(19) United States
(12) Patent Application Publication
(10) Pub. No.: US 2012/0094015 A1
(43) Pub. Date: Apr. 19, 2012

(54) Liquid crystal alignment agent and liquid crystal alignment film formed therefore and manufacturing method thereof

(75) Inventor: Huai-Pin Hsueh, Taichung (TW)

(73) Assignee: CHI-MEI CORPORATION

(21) Appl. No.: 13/373,187

(22) Filed: Nov. 8, 2011

Related U.S. Application Data
(62) Division of application No. 12/453,223, filed on May 4, 2009.

(30) Foreign Application Priority Data
May 9, 2008 (TW) 97117312
Apr. 14, 2009 (TW) 98112264

(51) Int. Cl. B05D 3/10

(52) U.S. Cl. 427/66

(57) ABSTRACT

The present invention provides a method of forming a liquid crystal alignment film comprising a process of coating a liquid crystal alignment agent onto a substrate, and then processing said alignment agent with dehydration/ring-closure reaction and free radical polymerization, wherein said liquid crystal alignment agent comprises a molecular compound containing at least 2 polymerizable maleamic acid groups (A), a polymer (B), and an organic solvent (C); wherein the polymer (B) comprises at least one kind of polymer obtained from condensation polymerization, which is selected from the groups consisting of polyester, polyesterimide, polyamide-imide acid, polyamide-imide, polyamide acid ester, polyamide and polyimide series polymer.

### CROSS REFERENCE

The present application is Division of co-pending U.S. application Ser. No. 12/453,223 by the same inventor filed on May 4, 2009.

### BACKGROUND OF THE INVENTION

1. Field of the Invention

The present invention relates to a novel liquid crystal alignment agent and liquid crystal alignment film formed therefore and manufacturing method use the liquid crystal alignment agent to form liquid crystal alignment film thereof, as well as a liquid crystal display element provided with a liquid crystal alignment film. More specifically, the present invention relates to a free radical polymerizable liquid crystal alignment agent having superior coating ability, and a manufacturing method, which comprises the process of coating the liquid crystal alignment agent onto a substrate, and processing the liquid crystal alignment agent with dehydration/ring-closure reaction and free radical polymerization, enables obtaining a liquid crystal alignment film with superior reliability, superior voltage holding ratio and easy control of pretilt angle, and enables the manufacture of a liquid crystal display element provided with a liquid crystal alignment film.

2. Description of the Prior Art

At present, the polymers such as polyamide acid, polyimide, and the like, are used as a liquid crystal alignment agent, after coating onto a substrate having a transparent conducting film, heating and alignment process to form a liquid crystal alignment film for the liquid crystal display element. Finally, two of the substrates coated with alignment film are placed in opposite directions to form a cell gap holding a liquid crystal layer between the two substrates.

Nematic liquid crystal display elements are predominantly used in general liquid crystal display elements, and concrete examples of types of nematic liquid crystal display elements actually used include: (1) a TN (Twisted Nematic) liquid crystal display element, comprising a liquid crystal alignment direction of one side substrate twisted at a 90 degree angle to a liquid crystal alignment direction of the other side substrate; (2) a STN (Super Twisted Nematic) liquid crystal display element, comprising a liquid crystal alignment direction of one side substrate twisted at an angle greater than 180 degrees to a liquid crystal alignment direction of the other side substrate; and (3) a TFT (Thin Film Transistor) liquid crystal display element which uses a thin film transistor.

The composition of alignment agents of the prior art comprises a polyamic acid and/or a polyimide of low molecular weight in linear polymer form (non-crosslinked structure), and a solvent. The aforementioned linear polyamic acid or polyimide is obtained by a polycondensation reaction between a diamine compound and a tetracarboxylic dianhydride compound. Manufacture of the alignment film includes coating the aforementioned alignment agent on a substrate, which then undergoes a high temperature imidization process and a rubbing process to form the alignment film. A Japanese Patent Publication No. 02-287324 discloses using a polyamic acid as a liquid crystal alignment agent, and a Japanese Patent Publication No. 06-082794 discloses using a polyimide as a liquid crystal alignment agent. However, using a polyamic acid as a liquid crystal alignment agent has the shortcoming of poor reliability; and using a polyimide as a liquid crystal alignment agent has the shortcomings of inferior coating ability and the defect of precipitation is occurred easily on the alignment film.

A Japanese Patent Publication No. 2001-122981 discloses using a maleimide compound of monomeric conformation as an alignment agent, wherein a substrate is directly coated with the maleimide compound, which then undergoes an addition polymerization using photo-radiation to form a polyimide alignment film having alignment effectiveness. However, such an alignment agent still has the problems of inferior coating ability and the defect of precipitation is occurred easily on the alignment film.

Furthermore, a Japanese Patent Publication No. 57-102966 discloses using a maleamic acid compound directly applied to an antifouling coating material. A Japanese Patent Publication No. 02-085238 discloses using a maleamic acid compound as a heat-resisting polyimide resin raw material, which can be used to serve as an optical material, used in machine parts, and so on. However, the aforementioned patents do not disclose use of a maleamic acid compound as a liquid crystal alignment agent, and its effectiveness to improve coating ability, control the pretilt angle, and so on, of the alignment agent.

### SUMMARY OF THE PRESENT INVENTION

The present invention provides a free radical polymerizable liquid crystal alignment agent having superior coating ability, and a manufacturing method, which comprises the process of coating the liquid crystal alignment agent onto a substrate, and processing the liquid crystal alignment agent with dehydration/ring-closure reaction and free radical polymerization, enables obtaining a liquid crystal alignment film with superior reliability, superior voltage holding ratio and easy control of pretilt angle, and enables the manufacture of a liquid crystal display element provided with a liquid crystal alignment film.

The free radical polymerizable liquid crystal alignment agent comprises a molecular compound containing at least 2 polymerizable maleamic acid groups (A), a polymer (B) and an organic solvent (C), wherein the polymer (B) comprises at least one kind of polymer obtained from condensation polymerization, which is selected from the groups consisting of polyester, polyesterimide, polyamide-imide acid, polyamide-imide, polyamide acid ester, polyamide and polyimide series polymer.

The molecular compound containing at least 2 polymerizable maleamic acid groups (A) comprises a compound (A-1) represented by the following Formula (1):

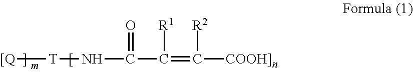

wherein Q is a monovalent organic group; T is a structure selected from an aliphatic, an alicyclic and an aromatic hydrocarbon group; R¹ and R² are hydrogen atoms or alkyl groups having 1 to 8 carbon atoms and may be the same or different; m is an integer of 1 or more; and n is an integer of 2 or more.

The present invention further provides a method of forming a liquid crystal alignment film comprises the process of coating the aforementioned liquid crystal alignment agent onto a substrate, and processing the liquid crystal alignment agent with dehydration/ring-closure reaction and free radical polymerization.

The liquid crystal display element of the present invention is provided with a liquid crystal alignment film manufactured using the aforementioned free radical polymerizable liquid crystal alignment agent.

The following provides a separate detailed description of each composition and manufacturing method of the present invention:

### Liquid Crystal Alignment Agent:

The free radical polymerizable liquid crystal alignment agent used by the liquid crystal display element of the present invention comprises the molecular compound containing at least 2 polymerizable maleamic acid groups (A), a polymer (B) and an organic solvent (C), and may further comprises an additive agent (D).

### The Molecular Compound Containing at Least 2 Polymerizable Maleamic Acid Groups (A):

There are no particular restrictions on the method used to manufacture the molecular compound containing at least 2 polymerizable maleamic acid groups (A) of the present invention, and is generally obtained from a reaction between maleic anhydride derivatives and multiple amino group compounds.

The molecular compound containing at least 2 polymerizable maleamic acid groups (A) of the present invention comprises the compound (A-1) represented by the following Formula (1):

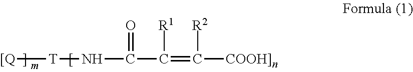

wherein Q is a monovalent organic group; T is a structure selected from an aliphatic, an alicyclic and an aromatic hydrocarbon group; R¹ and R² are hydrogen atoms or alkyl groups having 1 to 8 carbon atoms and may be the same or different; m is an integer of 1 or more; and n is an integer of 2 or more.

Wherein Q comprises the functional group represented by the following Formula (2):

R³-L- Formula (2)

wherein L is a divalent organic group selected from the group consisting of single bond, —O—, —CO—, —COO—, —OCO—, —NHCO—, —CONH—, —S—, methylene group, alkylene group having 2 to 6 carbon atoms and phenylene group; and R³ is a monovalent organic group selected from the group consisting of alkyl group having 6 to 30 carbon atoms, alicyclic or aromatic or heterocyclic ring skeleton having 4 to 40 carbon atoms and fluoroalkyl group having 6 to 12 carbon atoms.

A compound obtained from a reaction between maleic anhydride derivatives and diamine compounds is preferred for the compound (A-1) of the present invention, and the structure of the compound is represented by the following Formula (3):

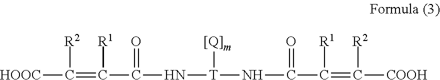

The compound represented by the Formula (4) is preferred for the compound represented by the Formula (3) of the present invention.

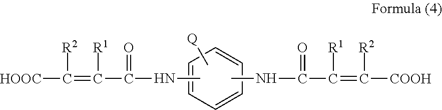

Based on control of pretilt angle stability, the compounds represented by the Formula (5) and Formula (6) are preferred for the compound represented by the Formula (4) of the present invention.

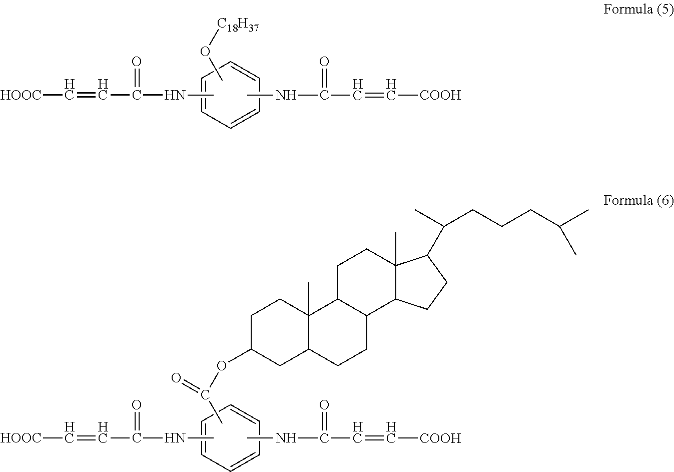

In addition to the aforementioned compound (A-1), the molecular compound containing at least 2 polymerizable maleamic acid groups (A) can further comprise a compound (A-2) according to needs. The compound (A-2) comprises the compound represented by the following Formula (7):

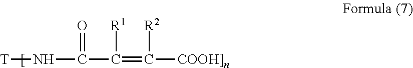

wherein T is a structure selected from an aliphatic, an alicyclic and an aromatic hydrocarbon group; R¹ and R² are hydrogen atoms or alkyl groups having 1 to 8 carbon atoms and may be the same or different; and n is an integer of 2 or more.

A compound obtained from a reaction between maleic anhydride derivatives and diamine compounds is preferred for the compound (A-2) of the present invention, and the structure of the compound is represented by the following Formula (8):

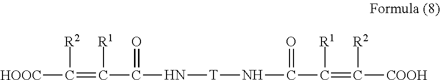

The compound represented by the Formula (9) is preferred for the compound represented by the Formula (8) of the present invention.

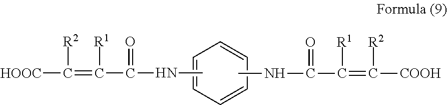

The molecular compound containing at least 2 polymerizable maleamic acid groups (A) of the present invention is based on a total of 100 parts by weight of the compound (A-1) and (A-2) therein. The amount of the compound (A-1) used is preferably 0.5 to 100 parts by weight, more preferably 2 to 100 parts by weight, and the most preferably 2 to 60 parts by weight; the amount of the compound (A-2) used is preferably 99.5 to 0 parts by weight, more preferably 98 to 0 parts by weight, and the most preferably 98 to 40 parts by weight. Based on a total of 100 parts by weight of the compound (A-1) and (A-2), if the amount of the compound (A-1) used is 0.5 to 100 parts by weight, an excellent pretilt angle is obtained, alignment is good, and the display of liquid crystal display elements is excellent. The pretilt angle range of TN (Twisted Nematic) liquid crystal display elements is preferably 3 to 5 degrees; the pretilt angle range of VA (Vertical Alignment) liquid crystal display elements is preferably 88 to 90 degrees.

The molecular compound containing at least 2 polymerizable maleamic acid groups (A) of the present invention contains at least 2 polymerizable functional groups, preferably 2 to 4 polymerizable functional groups, more preferably 2 polymerizable functional groups. If the molecular compound only contains 1 or no polymerizable functional group, the voltage holding ratio and reliability are poor. The molecular compound containing at least 2 polymerizable maleamic acid groups (A) of the present invention is able to form an alignment film provided with a crosslinked structure.

There are no particular restrictions on the method used to manufacture the molecular compound containing at least 2 polymerizable maleamic acid groups (A) of the present invention, and is generally obtained from a reaction between maleic anhydride derivatives and multiple amino group compounds in an organic solvent. Examples of maleic anhydride derivatives include maleic anhydride, 2,3-dimethylmaleic anhydride, 2-methylmaleic anhydride, 2,3-diethylmaleic anhydride, 2-ethylmaleic anhydride, and the like, among which maleic anhydride is preferred. Examples of multiple amino group compounds include diamine compounds, triamine compounds, tetraamine compounds, pentaamine compounds, and the like, among which diamine compounds, triamine compounds, and tetraamine compounds are preferred, more preferred is diamine compounds.

Examples of diamine compounds of the present invention include aromatic diamines such as p-phenylenediamine, m-phenylenediamine, o-phenylenediamine, 2,4-diaminotoluene, 1,4-diamino-2-methoxybenzene, 2,5-diaminoxylene, 1,3-diamino-4-chlorobenzene, 1,4-diamino-2,5-dichlorobenzene, 1,4-diamino-3-isopropylbenzene, 4,4′-diaminodiphenyl-2,2′-propane, 4,4′-diaminodiphenylmethane, 4,4′-diaminodiphenylethane, 4,4′-diaminodiphenylsulfide, 4,4′-diaminodiphenylsulfone, 3,3′-diaminodiphenylsulfone, 3,3′-dimethyl-4,4′-diaminobiphenyl, 3,3′-diethyl-4,4′-diaminobiphenyl, 4,4′-diaminobenzanilide, 4,4′-diaminodiphenylether, bis(4-aminophenyl)methylphosphine oxide, bis(3-aminophenyl)sulfoxide, bis(4-aminophenyl)phenylphosphine oxide, bis(4-aminophenyl)cyclohexylphosphine oxide, 4,4′-diaminodiphenylurea, 1,5-diaminonaphthalene, 1,8-diaminonaphthalene, 1,5-diaminoanthraquinone, 2,2′-dimethyl-4,4′-diaminobiphenyl, 5-amino-1-(4′-aminophenyl)-1,3,3-trimethylindane, 6-amino-1-(4′-aminophenyl)-1,3,3-trimethylindane, 3,4′-diaminodiphenylether, 2,2′-diaminobenzophenone, 3,3′-diaminobenzophenone, 3,4′-diaminobenzophenone, 4,4′-diaminobenzophenone, 2,2-bis[4-(4-aminophenoxy)phenyl]propane, 2,2-bis[4-(4-aminophenoxy)phenyl]hexafluoropropane, 2,2-bis(4-aminophenyl)hexafluoropropane, 2,2-bis[4-(4-aminophenoxy)phenyl]sulfone, 4,4′-bis(4-aminophenoxy)biphenyl, 1,4-bis(4-aminophenoxy)benzene, 1,3-bis(4-aminophenoxy)benzene, 1,3-bis(3-aminophenoxy)benzene, 9,9-bis(4-aminophenyl)-10-hydroanthracene, 2,7-diaminofluorene, 9,9-bis(4-aminophenyl)fluorene, 4,4′-methylene-bis(2-chloroaniline), 2,2′,5,5′-tetrachloro-4,4′-diaminobiphenyl, 2,2′-dichloro-4,4′-diamino-5,5′-dimethoxybiphenyl, 3,3′-dimethoxy-4,4′-diaminobiphenyl, 3,3′-diethoxy-4,4′-diaminobiphenyl, 4,4′-(p-phenyleneisopropylidene)bisaniline, 4,4′-(m-phenyleneisopropylidene)bisaniline, 2,2′-bis[4-(4-amino-2-trifluoromethylphenoxy)phenyl]hexafluoropropane, 4,4′-diamino-2,2′-bis(trifluoromethane)biphenyl, 4,4′-bis[(4-amino-2-trifluoromethyl)phenoxy]-octafluorobiphenyl, and the like.

Aliphatic and alicyclic diamines such as 1,2-diaminoethane, 1,3-diaminopropane, 1,4-diaminobutane, 1,5-diaminopentane, 1,6-diaminohexane, 1,7-diaminoheptane, 1,8-diaminooctane, 1,9-diaminononane, 1,10-diaminodecane, 1,3-diamino-2,2-dimethylpropane, 1,6-diamino-2,5-dimethylhexane, 1,7-diamino-2,5-dimethylheptane, 1,7-diamino-4,4-dimethylheptane, 1,7-diamino-3-methylheptane, 1,9-diamino-5-methylnonane, 2,11-diaminododecane, 1,12-diaminooctadecane, 1,2-bis(3-aminopropoxy)ethane, 4,4-diaminoheptamethylenediamine, 4,4′-diaminodicyclohexylmethane, 4,4′-diamino-3,3′-dimethyldicyclohexylamine, 1,3-diaminocyclohexane, 1,4-diaminocyclohexane, isophoronediamine, tetrahydrodicyclopentadienylenediamine, hexahydro-4,7-methanoindanylenedimethylenediamine, tricyclo[6•2•1•0^{2,7}]-undecylenedimethylenediamine, 4,4′-methylenebis(cyclohexylamine), and the like.

Diamines having two primary amino groups and a nitrogen atom other than the primary amino group in the molecule such as 2,3-diaminopyridine, 2,6-diaminopyridine, 3,4-diaminopyridine, 2,4-diaminopyrimidine, 5,6-diamino-2,3-dicyanopyrazine, 5,6-diamino-2,4-dihydroxypyrimidine, 2,4-diamino-1,3,5-triazine, 2,4-diamino-6-dimethylamino-1,3,5-triazine, 1,4-bis(3-aminopropyl)piperazine, 2,4-diamino-6-isopropoxy-1,3,5-triazine, 2,4-diamino-6-methoxy-1,3,5-triazine, 2,4-diamino-6-phenyl-1,3,5-triazine, 2,4-diamino-6-methyl-s-triazine, 4,6-diamino-2-vinyl-s-triazine, 2,7-diaminodibenzofuran, 2,7-diaminocarbazole, 3,7-diaminophenothiazine, 2,5-diamino-1,3,4-thiadiazole, 2,4-diamino-5-phenylthiazole, 2,6-diaminopurine, 5,6-diamino-1,3-dimethyluracil, 3,5-diamino-1,2,4-triazole, 6,9-diamino-2-ethoxyacridine lactate, 3,8-diamino-6-phenylphenanthridine, 1,4-diaminopiperazine, 3,6-diaminoacridine, bis(4-aminophenyl)phenylamine, and the compounds represented by the following Formula (10) and Formula (11).

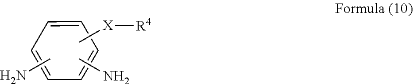

wherein R⁴ is a monovalent organic group having a ring structure containing a nitrogen atom selected from the group consisting of pyridine, pyrimidine, triazine, piperidine and piperazine; and X is a divalent organic group.

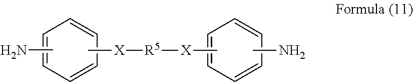

wherein R⁵ is a divalent organic group having a ring structure containing a nitrogen atom selected from the group consisting of pyridine, pyrimidine, triazine, piperidine and piperazine; and X is a divalent organic group with the proviso that a plurality of X's may be the same or different.

A monosubstituted phenylenediamine represented by the following Formula (12) and Formula (13); diaminoorganosiloxanes represented by the following Formula (14).

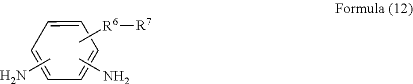

wherein R⁶ is a divalent organic group selected from the group consisting of —O—, —COO—, —OCO—, —NHCO—, —CONH— and —CO—; and R⁷ is a monovalent organic group having a group selected from the group consisting of a steroid skeleton, a trifluoromethyl group, a fluoro group or an alkyl group having 6 to 30 carbon atoms.

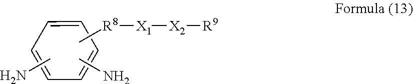

wherein R⁸ is a divalent organic group selected from the group consisting of —O—, —COO—, —OCO—, —NHCO—, —CONH— and —CO—; X¹ and X² are having the structure selected from alicyclic, aromatic and heterocyclic ring skeleton; and R⁹ is a monovalent organic group selected from the group consisting of an alkyl group having 3 to 18 carbon atoms, an alkoxy group having 3 to 18 carbon atoms, a fluoroalkyl group having 1 to 5 carbon atoms, a fluoroalkoxy group having 1 to 5 carbon atoms, a cyano group and halogen atoms.

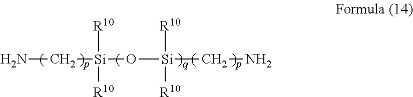

wherein R¹⁰ is a hydrocarbon group having 1 to 12 carbon atoms, with the proviso that a plurality of R¹⁰'s may be the same or different; p is an integer of 1 to 3, and q is an integer of 1 to 20.

And the compounds represented by the following Formulas (15) to (19). These diamine compounds may be used alone or in admixture of two or more.

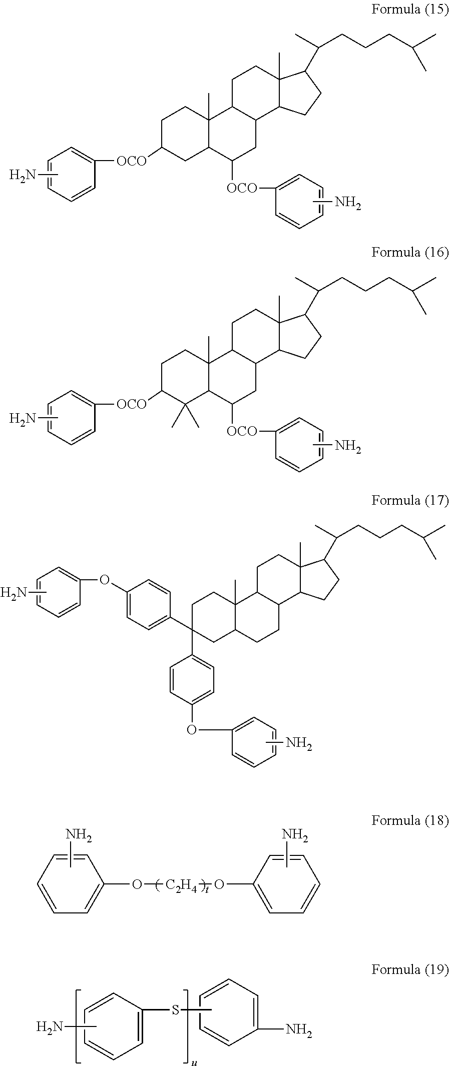

In the above Formulas, t is an integer of 2 to 12, and u is an integer of 1 to 5.

Among the aforementioned diamine compounds, p-phenylenediamine, 4,4′-diaminodiphenylmethane, 4,4′-diaminodiphenylsulfide, 1,5-diaminonaphthalene, 2,7-diaminofluorene, 4,4′-diaminodiphenylether, 2,2-bis[4-(4-aminophenoxy)phenyl]propane, 9,9-bis(4-aminophenyl)fluorene, 2,2-bis[4-(4-aminophenoxy)phenyl]hexafluoropropane, 2,2-bis(4-aminophenyl)hexafluoropropane, 4,4′-(p-phenyleneisopropylidene)bisaniline, 4,4′-(m-phenyleneisopropylidene)bisaniline, 1,4-diaminocyclohexane, 4,4′-methylenebis(cyclohexylamine), 1,4-bis(4-aminophenoxy)benzene, 4,4′-bis(4-aminophenoxy)biphenyl, 2,6-diaminopyridine, 3,4-diaminopyridine, 2,4-diaminopyrimidine, 3,6-diaminoacridine, a monosubstituted phenylenediamine represented by the above Formulas (12) and (13), and the compounds represented by the aforementioned Formulas (15) to (19) are preferred. In particular, 1-dodecyloxy-2,4-diaminobenzene, 1-hexadecyloxy-2,4-diaminobenzene, 1-octadecyloxy-2,4-diaminobenzene, and the compounds represented by the following Formulas (20) to (41) are most preferred in the monosubstituted phenylenediamine represented by the above Formulas (12) and (13).

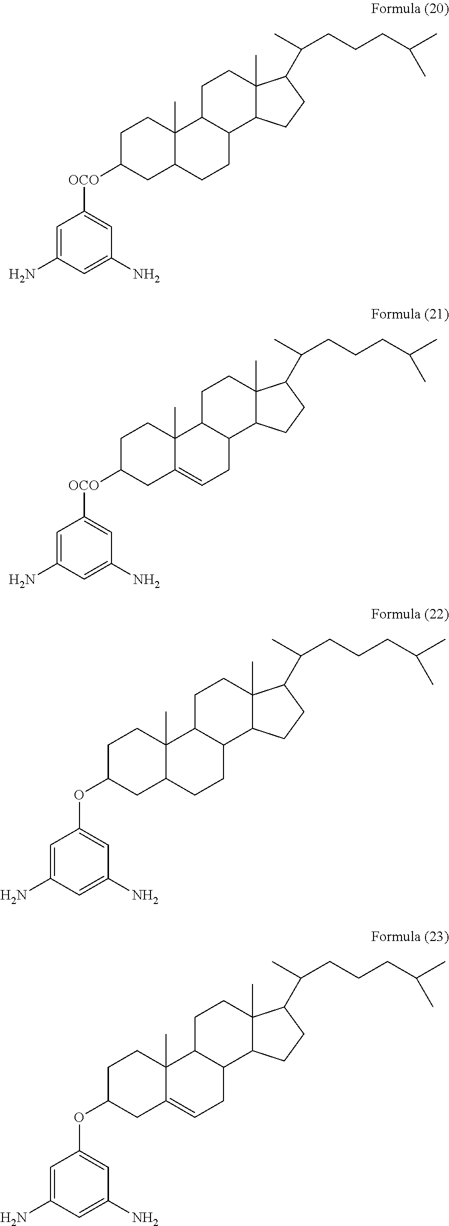

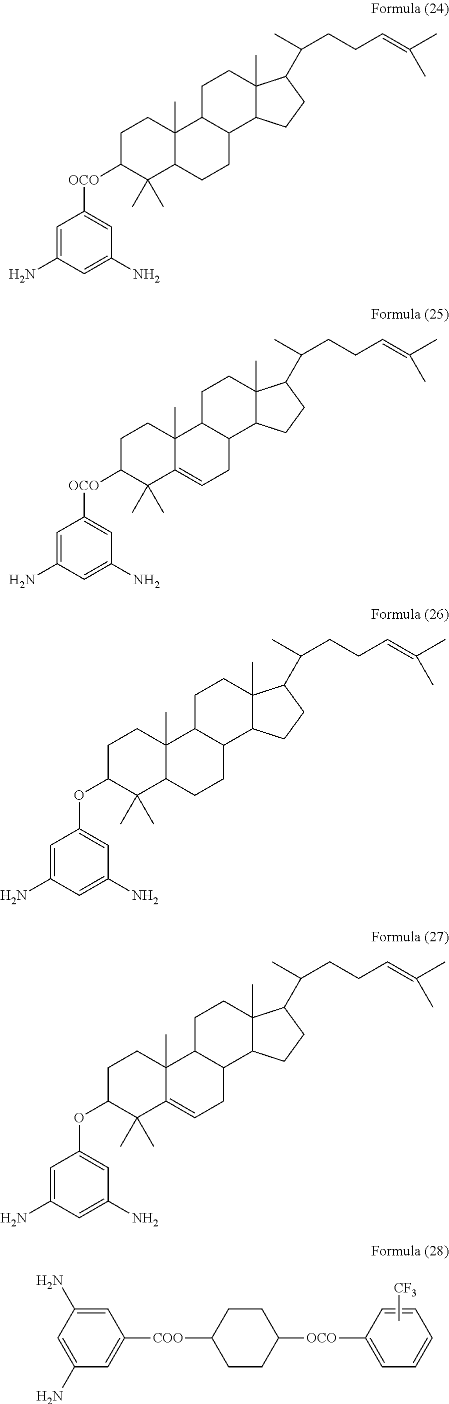

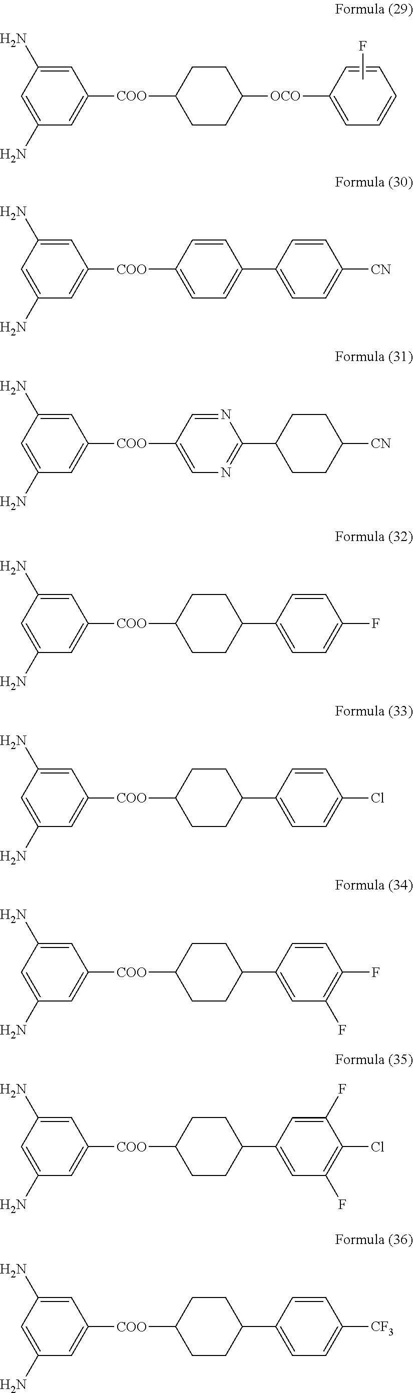

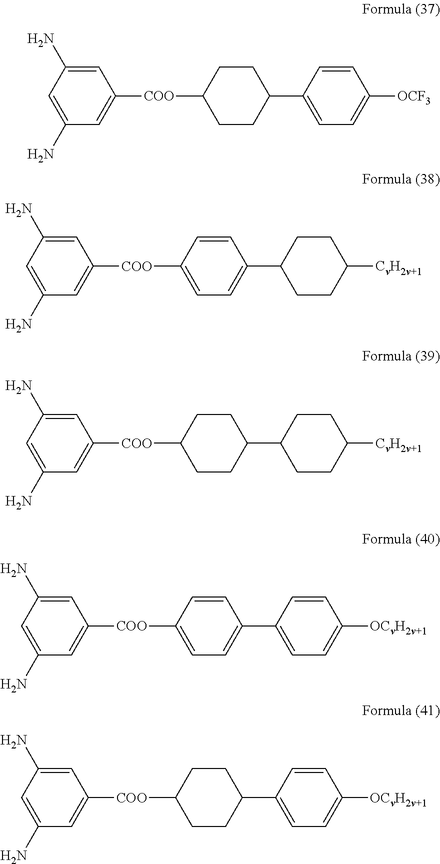

In the above formulas (38) to (41), v is an integer of 3 to 12.

In the manufacturing method of the molecular compound containing at least 2 polymerizable maleamic acid groups (A) of the present invention, the organic solvent is required to dissolve the reactant, but there are no particular limitations on the type of organic solvent. Examples of solvents of the present invention include N-methyl-2-pyrrolidone, N,N-dimethylacetamide, N,N-dimethylformamide, dimethylsulfoxide, N-methylcaprolactam, γ-butyrolactone, acetone, methyl ethyl ketone, butyl cellosolve, dioxane, tetrahydrofuran, and the like.

In the manufacturing method of the molecular compound containing at least 2 polymerizable maleamic acid groups (A), the proportion of the maleic anhydride derivatives and multiple amino group compounds used is taken from mole fractions of acid anhydride groups of the maleic anhydride derivatives to amino groups of the multiple amino group compounds as standards, and in general is 1.0 to 2.5, preferably 1.0 to 2.0, and more preferably 1.0 to 1.8. The reaction temperature for the maleic anhydride derivatives and the multiple amino group compounds in the organic solvent is generally 0 to 100° C., preferably 0 to 80° C., and more preferably 0 to 70° C. The reaction time is generally 1 to 5 hours, preferably 2 to 4 hours.

### Polymer (B):

The polymer (B) of the present invention comprises at least one kind of polymer obtained from condensation polymerization, which is selected from the groups consisting of polyester, polyester imide, polyamide-imide acid, polyamide-imide, polyamide acid ester, polyamide and polyimide series polymer, in which, the polyimide series polymer comprises a polyamic acid (B-1) and/or a polyimide (B-2) and/or a polyimide series block copolymer (B-3).

The polyimide series block copolymer (B-3) comprises a polyamic acid block copolymer (B-3-1) and/or a polyimide block copolymer (B-3-2) and/or a polyamic acid-polyimide block copolymer (B-3-3).

The polyimide series block copolymer (B-3) is exemplified by the polyamic acid block copolymer (B-3-1) comprising a first polyamic acid block and a second polyamic acid block having a different structure from the first block, represented by the following Formula (42).

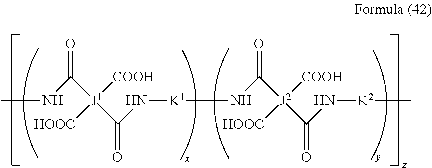

wherein J¹ and J² are tetravalent organic groups which can be the same or different; K¹ and K² are divalent organic groups which can be the same or different; K¹ and K² are not the same when J¹=J² and that J¹ and J² are not the same when K¹=K², or J¹ and J², K¹ and K² are different at the same time; x and y are an integer of 1 to 2,000, and z is an integer of 1 to 100.

The polyimide block copolymer (B-3-2) comprises a first polyimide block and a second polyimide block having a different structure from the first block, represented by the following Formula (43).

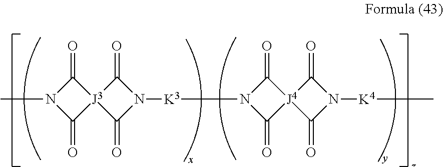

wherein J³ and J⁴ are tetravalent organic groups which can be the same or different; K³ and K⁴ are divalent organic groups which can be the same or different; K³ and K⁴ are not the same when J³=J⁴ and that J³ and J⁴ are not the same when K³=K⁴, or J³ and J⁴, K³ and K⁴ are different at the same time; x and y are an integer of 1 to 2,000, and z is an integer of 1 to 100.

In addition, the polyamic acid-polyimide block copolymer (B-3-3) comprises a polyamic acid block and a polyimide block, represented by the following Formula (44).

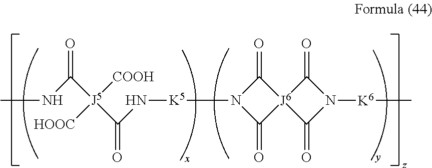

wherein J⁵ and J⁶ are tetravalent organic groups which can be the same or different; K⁵ and K⁶ are divalent organic groups which can be the same or different; K⁵ and K⁶ are not the same when J⁵=J⁶ and that J⁵ and J⁶ are not the same when K⁵=K⁶, or K⁵ and K⁶, J⁵ and J⁶ are different at the same time; x and y are an integer of 1 to 2,000, and z is an integer of 1 to 100.

The polyimide series polymer is preferred as the polymer (B) in the present invention, but there are no particular limitations on the tetracarboxylic dianhydrides and diamine compounds used by the polyimide series polymer. Examples of tetracarboxylic dianhydride compounds include aliphatic and alicyclic tetracarboxylic dianhydrides such as ethanetetracarboxylic dianhydride, butanetetracarboxylic dianhydride, 1,2,3,4-cyclobutanetetracarboxylic dianhydride, 1,2-dimethyl-1,2,3,4-cyclobutanetetracarboxylic dianhydride, 1,3-dimethyl-1,2,3,4-cyclobutanetetracarboxylic dianhydride, 1,3-dichloro-1,2,3,4-cyclobutanetetracarboxylic dianhydride, 1,2,3,4-tetramethyl-1,2,3,4-cyclobutanetetracarboxylic dianhydride, 1,2,3,4-cyclopentanetetracarboxylic dianhydride, 1,2,4,5-cyclohexanetetracarboxylic dianhydride, 1,2,5,6-cyclohexanetetracarboxylic dianhydride, 3,3′,4,4′-dicyclohexanetetracarboxylic dianhydride, bicycloheptanetetracarboxylic dianhydride, 3,3′-bicyclohexyl-1,1′,2,2′-tetracarboxylic dianhydride, 2,3,5-tricarboxycyclopentylacetic dianhydride, 3,5,6-tricarboxynorbornane-2-acetic dianhydride, 2,3,4,5-tetrahydrofuran tetracarboxylic dianhydride, tetracyclo[6•2•1^{1,3}•0^{2,7}]dodecane-4,5,9,10-tetracarboxylic dianhydride, 3,4-dicarboxy-1,2,3,4-tetrahydronaphthalene-1-succinic acid dianhydride, 1,3,3a,4,5,9b-hexahydro-5-(tetrahydro-2,5-dioxo-3-furanyl)-naphtho[1,2-c]-furan-1,3-dione, 1,3,3a,4,5,9b-hexahydro-5-methyl-5-(tetrahydro-2,5-dioxo-3-furanyl)-naphtho[1,2-c]-furan-1,3-dione, 1,3,3a,4,5,9b-hexahydro-5-ethyl-5-(tetrahydro-2,5-dioxo-3-furanyl)-naphtho[1,2-c]-furan-1,3-dione, 1,3,3a,4,5,9b-hexahydro-7-methyl-5-(tetrahydro-2,5-dioxo-3-furanyl)-naphtho[1,2-c]-furan-1,3-dione, 1,3,3a,4,5,9b-hexahydro-7-ethyl-5-(tetrahydro-2,5-dioxo-3-furanyl)-naphtho[1,2-c]-furan-1,3-dione, 1,3,3a,4,5,9b-hexahydro-8-methyl-5-(tetrahydro-2,5-dioxo-3-furanyl)-naphtho[1,2-c]-furan-1,3-dione, 1,3,3a,4,5,9b-hexahydro-8-ethyl-5-(tetrahydro-2,5-dioxo-3-furanyl)-naphtho[1,2-c]-furan-1,3-dione, 1,3,3a,4,5,9b-hexahydro-5,8-dimethyl-5-(tetrahydro-2,5-dioxo-3-furanyl)-naphtho[1,2-c]-furan-1,3-dione, 5-(2,5-dioxotetrahydrofuranyl)-3-methyl-3-cyclohexene-1,2-dicarboxylic dianhydride, bicyclo[2•2•2]-octa-7-ene-2,3,5,6-tetracarboxylic dianhydride, bicyclo[3•3•0]-octane-2,4,6,8-tetracarboxylic dianhydride, 3-oxabicyclo[3•2•1]-octane-2,4-dione-6-spiro-3′-(tetrahydrofuran-2′,5′-dione), and compounds represented by the following Formulas (45) and (46):

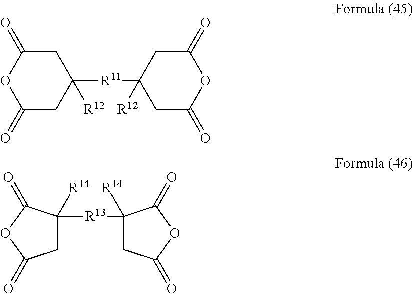

wherein R¹¹ in the Formula (45) and R¹³ in the Formula (46) are a divalent organic group having an aromatic ring; and R¹² in the Formula (45) and R¹⁴ in the Formula (46) are each a hydrogen atom or alkyl group with the proviso that a plurality of R¹²'s and a plurality of R¹⁴'s may be the same or different.

Aromatic tetracarboxylic dianhydrides such as pyromellitic dianhydride, 2,3,3′,4′-benzophenonetetracarboxylic dianhydride, 3,3′,4,4′-benzophenonetetracarboxylic dianhydride, 2,2′,3,3′-biphenyltetracarboxylic dianhydride, 2,3,3′,4-biphenyltetracarboxylic dianhydride, 3,3′,4,4′-biphenyltetracarboxylic dianhydride, 3,3′,4,4′-biphenylsulfonetetracarboxylic dianhydride, 1,2,5,6-naphthalenetetracarboxylic dianhydride, 1,4,5,8-naphthalenetetracarboxylic dianhydride, 2,3,6,7-naphthalenetetracarboxylic dianhydride, 2,3,6,7-anthracenetetracarboxylic dianhydride, 1,2,5,6-anthracenetetracarboxylic dianhydride, bis(3,4-dicarboxyphenyl)ether dianhydride, bis(3,4-dicarboxyphenyl)sulfone dianhydride, bis(3,4-dicarboxyphenyl)methane dianhydride, 2,2-bis(3,4-dicarboxyphenyl)propane dianhydride, 1,1,1,3,3,3-hexafluoro-2,2-bis(3,4-dicarboxyphenyl)propane dianhydride, bis(3,4-dicarboxyphenyl)dimethylsilane dianhydride, bis(3,4-dicarboxyphenyl)diphenylsilane dianhydride, 2,3,4,5-pyridinetetracarboxylic dianhydride, 2,6-bis(3,4-dicarboxyphenyl)pyridine dianhydride, 3,3′,4,4′-dimethyldiphenylsilanetetracarboxylic dianhydride, 3,3′,4,4′-tetraphenylsilanetetracarboxylic dianhydride, 1,2,3,4-furantetracarboxylic dianhydride, 4,4′-bis(3,4-dicarboxyphenylmethyl)diphenylmethane dianhydride, 4,4′-bis(3,4-dicarboxyphenylmethyl)diphenylethane dianhydride, 4,4′-bis(3,4-dicarboxyphenylmethyl)diphenylpropane dianhydride, 4,4′-bis(3,4-dicarboxyphenoxy)diphenylmethane dianhydride, 4,4′-bis(3,4-dicarboxyphenoxy)diphenylethane dianhydride, 4,4′-bis(3,4-dicarboxyphenoxy)diphenylpropane dianhydride, 4,4′-bis(3,4-dicarboxyphenoxy)diphenylsulfide dianhydride, 4,4′-bis(3,4-dicarboxyphenoxy)diphenylsulfone dianhydride, 3,3′,4,4′-perfluoropropylidenediphthalic dianhydride, 3,3′,4,4′-perfluoroisopropylidenediphthalic dianhydride, bis(phthalic acid)phenylphosphine oxide dianhydride, bis(phthalic acid)phenylsulphine oxide dianhydride, p-phenylene-bis(triphenylphthalic acid)dianhydride, m-phenylene-bis(triphenylphthalic acid)dianhydride, bis(triphenylphthalic acid)-4,4′-diphenylether dianhydride, bis(triphenylphthalic acid)-4,4′-diphenylmethane dianhydride, ethylene glycol-bis(anhydrotrimellitate), propylene glycol-bis(anhydrotrimellitate), 1,4-butanediol-bis(anhydrotrimellitate), 1,6-hexanediol-bis(anhydrotrimellitate), 1,8-octanediol-bis(anhydrotrimellitate), 2,2-bis(4-hydroxyphenyl)propane-bis(anhydrotrimellitate), and compounds containing steroid skeletons represented by the following Formulas (47) to (50). These compounds may be used alone or in admixture of two or more.

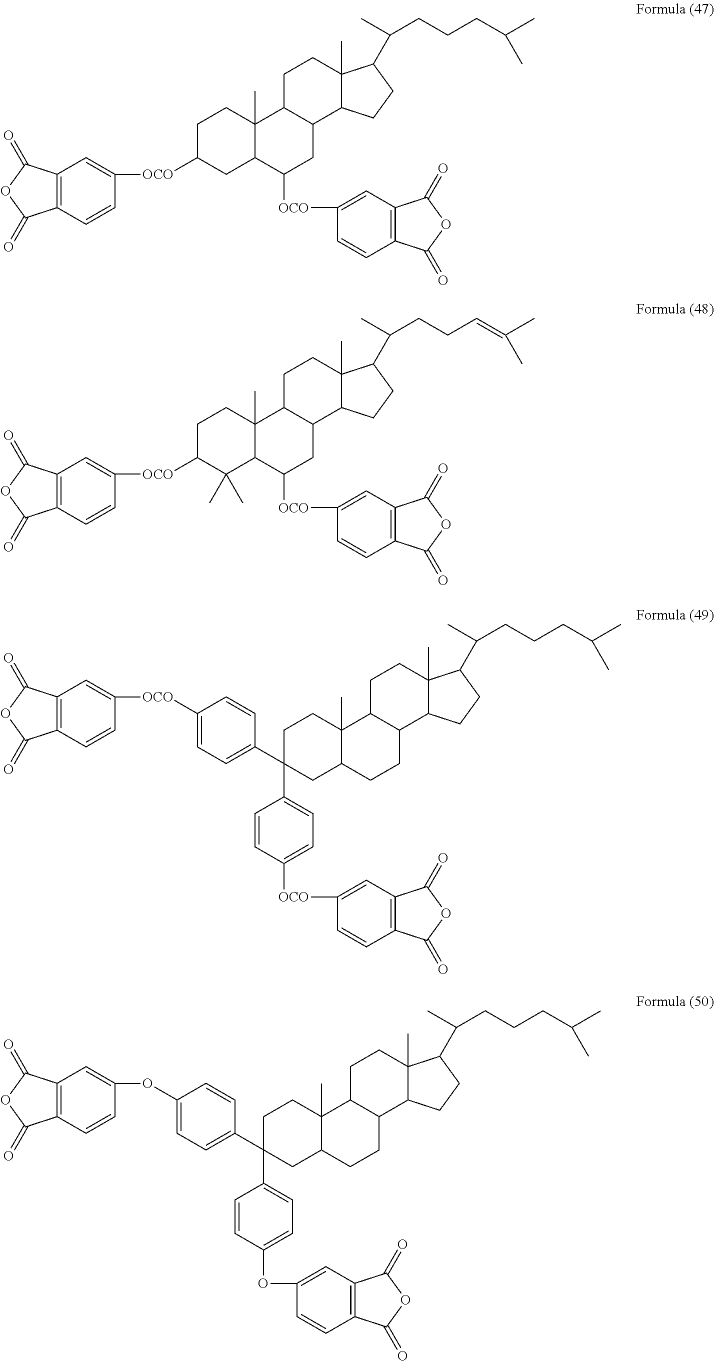

Among the aforementioned tetracarboxylic dianhydrides, 1,2,3,4-cyclobutanetetracarboxylic dianhydride, 1,2,3,4-cyclopentanetetracarboxylic dianhydride, 2,3,5-tricarboxycyclopentylacetic dianhydride, 3,4-dicarboxy-1,2,3,4-tetrahydronaphthalene-1-succinic acid dianhydride, pyromellitic dianhydride, and 3,3′,4,4′-biphenylsulfonetetracarboxylic dianhydride are preferred.

Examples of diamine compounds used in the polymer (B) of the present invention are the same as the aforementioned descriptions of the diamine compounds of the molecular compound containing at least 2 polymerizable maleamic acid groups (A).

The polyamic acid (B-1) in the polymer (B) of the present invention is obtained from a polycondensation reaction between tetracarboxylic dianhydride compounds and diamine compounds, in which the proportion of the tetracarboxylic dianhydride compounds and diamine compounds corresponds to per 1 equivalent of the amino groups of the diamine compounds, and the acid anhydride groups of the tetracarboxylic dianhydride compounds is generally 0.2 to 2 equivalents, preferably 0.8 to 1.2 equivalents.

In the polycondensation reaction of the polyamic acid (B-1), reaction temperature of the tetracarboxylic dianhydride compounds and diamine compounds in an organic solvent is generally −20 to 150° C., preferably 0 to 100° C. As long as the organic solvent is able to dissolve the reactants and the products, there are no particular limitations on the type of organic solvent used. Examples of the organic solvent include aprotic polar solvents such as N-methyl-2-pyrrolidone, N,N-dimethylacetamide, N,N-dimethylformamide, dimethylsulfoxide, γ-butyrolactone, tetramethylurea, hexamethylphosphoryl triamide, and the like; and phenolic solvents such as m-cresol, xylenol, phenol, halogenated phenols, and the like.

The aforementioned organic solvent can be used in combination with a poor solvent such as alcohol, ketone, ester, ether, halogenated hydrocarbon, hydrocarbon, and the like in such an amount that does not cause precipitation of the formed polymer. Specific examples of the poor solvent include methyl alcohol, ethyl alcohol, isopropyl alcohol, cyclohexanol, ethylene glycol, propylene glycol, 1,4-butanediol, triethylene glycol, acetone, methyl ethyl ketone, methyl isobutyl ketone, cyclohexanone, methyl acetate, ethyl acetate, butyl acetate, diethyl oxalate, diethyl malonate, diethyl ether, ethylene glycol methyl ether, ethylene glycol ethyl ether, ethylene glycol n-propyl ether, ethylene glycol i-propyl ether, ethylene glycol n-butyl ether, ethylene glycol dimethyl ether, ethylene glycol ethyl ether acetate, diethylene glycol dimethyl ether, tetrahydrofuran, dichloromethane, 1,2-dichloroethane, 1,4-dichlorobutane, trichloroethane, chlorobenzene, o-dichlorobenzene, hexane, heptane, octane, benzene, toluene, xylene, and the like.

The aforementioned obtained polyamic acid (B-1) reaction solution is poured into a large amount of the poor solvent to obtain a precipitate which is then dried under low pressure drying or low pressure distillation to obtain the polyamic acid (B-1). In addition, the polyamic acid (B-1) is further dissolved in an organic solvent and precipitated with a poor solvent, or dried under low pressure distillation using an evaporator is carried out once or a plurality of times to purify the polyamic acid (B-1).

In the polymer (B) of the present invention, the polyimide (B-2) is obtained by further dehydration/ring-closure reaction (imidization) of the polyamic acid (B-1).

Examples of imidization methods of the polyamic acid (B-1) such as dissolving the polyamic acid (B-1) in an organic solvent, and heating in the presence of a dehydrator and an imidization catalyst to implement a dehydration/ring-closure reaction. Heating temperature of the imidization process is generally 40 to 200° C. preferably 80 to 150° C. Examples of the dehydrator used include an acid anhydride compound such as acetic anhydride, propionic anhydride, trifluoroacetic anhydride, and the like. The amount of the dehydrator used is preferably 0.01 to 20 moles per mole of the polyamic acid (B-1). Examples of the imidization catalyst used include a tertiary amine such as pyridine, collidine, lutidine, triethylamine, and the like. The amount of the imidization catalyst used is preferably 0.5 to 10 moles per mole of the dehydrator used.

Examples of the solvents used in the imidization are the same as the solvents mentioned in the polycondensation reaction of the aforementioned polyamic acid (B-1).

In addition, the same operation as in the method of purifying a polyamic acid (B-1) is carried out on the polyimide (B-2) reaction solution to purify the polyimide (B-2).

In the polymer (B) of the present invention, the polyimide series block copolymer (B-3) is synthesized according to the type of polymers, for example, the polyamic acid block copolymer (B-3-1), the polyimide block copolymer (B-3-2), and the polyamic acid-polyimide block copolymer (B-3-3). In the synthesis reaction of the polyimide series block copolymer (B-3), the polyimide block copolymer (B-3) is obtained by further polycondensation reaction of compounds selected from the aforementioned polyamic acid (B-1), the polyimide (B-2), the tetracarboxylic dianhydride compound, the diamine compound in an organic solvent. For example: a first and a second polyamic acids (B-1) are structurally different from each other and terminal groups of each polyamic acid are different; a first and a second polyimides (B-2) are structurally different from each other and terminal groups of each polyimide are different; a polyamic acid (B-1) and a polyimide (B-2) are structurally different and having different terminal groups; a polyamic acid (B-1) and a tetracarboxylic dianhydride and a diamine, wherein at least one of the tetracarboxylic dianhydride and diamine used is structurally different from which used in the polycondensation reaction of the polyamic acid (B-1); a polyimide (B-2) and a tetracarboxylic dianhydride and a diamine, wherein at least one of the tetracarboxylic dianhydride and diamine used is structurally different from which used in the polycondensation reaction of the polyimide (B-2); a polyamic acid (B-1) and a polyimide (B-2) and a tetracarboxylic dianhydride and a diamine, wherein at least one of the tetracarboxylic dianhydride and diamine used is structurally different from which used in the polycondensation reaction of the polyamic acid (B-1) and the polyimide (B-2); a first and a second polyamic acids (B-1) are structurally different from each other and a tetracarboxylic dianhydride and a diamine; a first and a second polyimides (B-2) are structurally different from each other and a tetracarboxylic dianhydride and a diamine; a first and a second polyamic acids (B-1) having acid anhydride terminal groups are structurally different from each other and a diamine; a first and a second polyamic acids (B-1) having amino terminal groups are structurally different from each other and a tetracarboxylic dianhydride; a first and a second polyimides (B-2) having acid anhydride terminal groups are structurally different from each other and a diamine; a first and a second polyimides (B-2) having amino terminal groups are structurally different from each other and a tetracarboxylic dianhydride; and the like.

In the polycondensation reaction of the polyimide series block copolymer (B-3), the reaction temperature is generally 0 to 200° C., preferably 0 to 100° C., and examples of the solvents used are the same as the solvents mentioned in the polycondensation reaction of the aforementioned polyamic acid (B-1).

In addition, the same operation as in the method of purifying a polyamic acid (B-1) is carried out on the polyimide series block copolymer (B-3) reaction solution thus obtained to purify the polyimide series block copolymer (B-3).

Based on a total of 100 parts by weight of the molecular compound containing at least 2 polymerizable maleamic acid groups (A) and the polymer (B), the amount of the molecular compound containing at least 2 polymerizable maleamic acid groups (A) to the polymer (B) used in the present invention is generally 99/1 to 1/99 parts by weight, preferably 90/10 to 10/90 parts by weight, more preferably 85/15 to 15/85 parts by weight, and the most preferably 70/30 to 30/70 parts by weight. If the amount of the aforementioned molecular compound containing at least 2 polymerizable maleamic acid groups (A) used is higher than 99 parts by weight, and the amount of the polymer (B) used is lower than 1 part by weight, and a printing method is used to implement coating, a problem of inferior film formability of the alignment agent occurs. If the amount of the aforementioned molecular compound containing at least 2 polymerizable maleamic acid groups (A) is lower than 1 part by weight, and the amount of the polymer (B) is higher than 99 parts by weight, problems of precipitation of the alignment agent easily when coating and poor reliability of the formed alignment film occur.

### Organic Solvent (C):

The organic solvent of the free radical polymerizable liquid crystal alignment agent of the present invention can be selected from the solvents used during the manufacturing process of the aforementioned molecular compound containing at least 2 polymerizable maleamic acid groups (A) and the manufacturing process of the polymer (B), and is not further described here. Based on a total of 100 parts by weight of the molecular compound containing at least 2 polymerizable maleamic acid groups (A) and the polymer (B), the amount of the organic solvent (C) used in the present invention is generally 100 to 10,000 parts by weight, preferably 300 to 5,000 parts by weight, and more preferably 500 to 3,000 parts by weight.

### Additive Agent (D):

In addition, the liquid crystal alignment agent of the present invention may contain a functional silane-containing compound or an epoxy compound in limits that do not impair the targeted physical properties in order to improve adhesion to the surface of the substrate. Examples of the functional silane-containing compound include 3-aminopropyltrimethoxysilane, 3-aminopropyltriethoxysilane, 2-aminopropyltrimethoxysilane, 2-aminopropyltriethoxysilane, N-(2-aminoethyl)-3-aminopropyltrimethoxysilane, N-(2-aminoethyl)-3-aminopropylmethyldimethoxysilane, 3-ureidopropyltrimethoxysilane, 3-ureidopropyltriethoxysilane, N-ethoxycarbonyl-3-aminopropyltrimethoxysilane, N-ethoxycarbonyl-3-aminopropyltriethoxysilane, N-triethoxysilylpropyltriethylenetriamine, N-trimethoxysilylpropyltriethylenetriamine, 10-trimethoxysilyl-1,4,7-triazadecane, 10-triethoxysilyl-1,4,7-triazadecane, 9-trimethoxysilyl-3,6-diazanonylacetate, 9-triethoxysilyl-3,6-diazanonylacetate, N-benzyl-3-aminopropyltrimethoxysi lane, N-benzyl-3-aminopropyltriethoxysilane, N-phenyl-3-aminopropyltrimethoxysilane, N-phenyl-3-aminopropyltriethoxysi lane, N-bis(oxyethylene)-3-aminopropyltrimethoxysilane, N-bis(oxyethylene)-3-aminopropyltriethoxysilane, and the like.

Examples of the epoxy compound include ethylene glycol diglycidyl ether, polyethylene glycol diglycidyl ether, propylene glycol diglycidyl ether, tripropylene glycol diglycidyl ether, polypropylene glycol diglycidyl ether, neopentyl glycol diglycidyl ether, 1,6-hexanediol diglycidyl ether, glycerin diglycidyl ether, 2,2-dibromoneopentyl glycol diglycidyl ether, 1,3,5,6-tetragylcidyl-2,4-hexanediol, N,N,N′,N′-tetragylcidyl-m-xylenediamine, 1,3-bis(N,N-diglycidylaminomethyl)cyclohexane, N,N,N′,N′-tetragylcidyl-4,4′-diaminodiphenylmethane, 3-(N-allyl-N-glycidyl)aminopropyltrimethoxysilane, 3-(N,N-diglycidyl)aminopropyltrimethoxysilane, and the like.

In addition, the free radical polymerizable liquid crystal alignment agent of the present invention may contain other copolymerizable monomers in limits that do not impair the targeted physical properties. Examples of the copolymerizable monomers include unsaturated monocarboxylic acids, such as acrylic acid, methacrylic acid, 2-methacryloyl oxyethyl succinate monoester, butenoic acid, α-chloroacrylic acid, ethacrylic acid, cinnamic acid, and the like; unsaturated dicarboxylic acids (or its anhydrides), such as maleic acid, maleic anhydride, fumaric acid, itaconic acid, itaconic anhydride, citraconic acid, citraconic anhydride, and the like; unsaturated polycarboxylic acids (or its anhydrides) having at least 3 carboxyl groups in the molecules and the like; vinyl aromatic compounds such as styrene, α-methylstyrene, vinyltoluene, p-chlorostyrene, methoxystyrene, and the like; maleimides, such as N-phenylmaleimide, N-o-hydroxyphenylmaleimide, N-m-hydroxyphenylmaleimide, N-p-hydroxyphenylmaleimide, N-o-methylphenylmaleimide, N-m-methylphenylmaleimide, N-ρ-methylphenylmaleimide, N-o-methoxyphenylmaleimide, N-m-methoxyphenylmaleimide, N-ρ-methoxyphenylmaleimide, N-cyclohexylmaleimide, and the like; unsaturated carboxylates, such as methyl acrylate, methyl methacrylate, ethyl acrylate, ethyl methacrylate, n-propyl acrylate, n-propyl methacrylate, iso-propyl acrylate, iso-propyl methacrylate, n-butyl acrylate, n-butyl methacrylate, iso-butyl acrylate, iso-butyl methacrylate, sec-butyl acrylate, sec-butyl methacrylate, tert-butyl acrylate, tert-butyl methacrylate, 2-hydroxyethyl acrylate, 2-hydroxyethyl methacrylate, 2-hydroxypropyl acrylate, 2-hydroxypropyl methacrylate, 3-hydroxypropyl acrylate, 3-hydroxypropyl methacrylate, 2-hydroxybutyl acrylate, 2-hydroxybutyl methacrylate, 3-hydroxybutyl acrylate, 3-hydroxybutyl methacrylate, 4-hydroxybutyl acrylate, 4-hydroxybutyl methacrylate, allyl acrylate, allyl methacrylate, benzyl acrylate, benzyl methacrylate, phenyl acrylate, phenyl methacrylate, methoxy triethylene glycol acrylate, methoxy triethylene glycol methacrylate, lauryl methacrylate, tetradecyl methacrylate, cetyl methacrylate, octadecyl methacrylate, eicosyl methacrylate, docosyl methacrylate, and the like; unsaturated amino alkyl carboxylates, such as N,N-dimethylaminoethyl acrylate, N,N-dimethylaminoethyl methacrylate, N,N-diethylaminopropyl acrylate, N,N-dimethylaminopropyl methacrylate, N,N-dibutylaminopropyl acrylate, N,t-butylaminoethyl methacrylate, and the like; unsaturated glycidyl carboxylates, such as glycidyl acrylate, glycidyl methacrylate, and the like; vinyl carboxylates, such as vinyl acetate, vinyl propionate, vinyl butyrate, and the like; unsaturated ethers, such as vinyl methyl ether, vinyl ethyl ether, allyl glycidyl ether, methallyl glycidyl ether, and the like; vinyl cyanides, such as acrylonitrile, methacrylonitrile, α-chloroacrylonitrile, vinylidene cyanide, and the like; unsaturated amides, such as acrylamide, methacrylamide, α-chloroacrylamide, N-hydroxyacrylamide, N-hydroxyethyl methacrylamide, and the like; and aliphatic conjugated dienes, such as 1,3-butadiene, iso-propylene, chlorobutadiene, and the like.

### Manufacturing Method of the Liquid Crystal Alignment Agent:

The free radical polymerizable liquid crystal alignment agent used by the liquid crystal display element of the present invention comprises the molecular compound containing at least 2 polymerizable maleamic acid groups (A), the polymer (B), and the organic solvent (C), and may further comprise the additive agent (D). The liquid crystal alignment agent is manufactured by uniformly mixing the aforementioned molecular compound containing at least 2 polymerizable maleamic acid groups (A), the polymer (B) and the additive agent (D) dissolved in the organic solvent (C), and the modulating temperature of the alignment agent is generally 0 to 200° C., preferably 0 to 100° C.

### Manufacturing Method of the Liquid Crystal Alignment Film:

Manufacturing method use the liquid crystal alignment agent to form the liquid crystal alignment film of the present invention comprises coating the aforementioned free radical polymerizable liquid crystal alignment agent on a substrate, after which dehydration/ring-closure reaction and free radical polymerization are processed to obtain the liquid crystal alignment film. The liquid crystal alignment agent of the present invention is applied to one side of the substrate having a transparent conductive film by a roller coating method, spinner coating method, printing method, ink-jet method, and the like, in which the printing method is preferred. The coating surface is then heated to form a coating film.

Examples of the aforementioned substrate include alkali-free glass, soda-lime glass, Pyrex glass, silica glass, and the like used in liquid crystal display devices; polyethylene terephthalate, polybutylene terephthalate, polyether sulfone, polycarbonate, and the like. The transparent conductive film formed on one side of the substrate is a NESA film (NESA is a registered trademark of PPG Industries, USA) made from tin oxide (SnO₂) or an ITO film made from indium oxide-tin oxide (In₂O₃—SnO₂), and the like.

Before the application of the liquid crystal alignment agent, in order to improve the adhesion of the coating film to the substrate and the transparent conductive film, a functional silane-containing compound or functional titanium-containing compound may be applied to the surface of the substrate.

The heating process to form the alignment film comprises pre-bake and post-bake treatment after coating with the liquid crystal alignment agent, in which the pre-bake causes an organic solvent to volatilize and form a coating film. The temperature of the pre-bake treatment is generally 30 to 120° C., preferably 50 to 100° C.

Furthermore, after the coating film is formed, the post-bake treatment is carried out, and dehydration/ring-closure reaction (imidization) and free radical polymerization are carried out simultaneously to form the imidized coating alignment film. The temperature of the post-bake treatment is generally 150 to 300° C., preferably 180 to 280° C., and more preferably 200 to 250° C.

During the process of forming the alignment film of the present invention, ultraviolet irradiation can be implemented in advance, and then post-bake is carried out. Moreover, photopolymerization initiators or thermal polymerization initiators can be added to the alignment agent according to needs. The heating process (heat polymerization) is the preferred method for the alignment film processing of the present invention.

The dehydration/ring-closure reactions (imidization) cause maleamic acid groups to form maleimide groups. An example of such a reaction can be represented by the following Equation (1) using the compound with Formula (5) as an example:

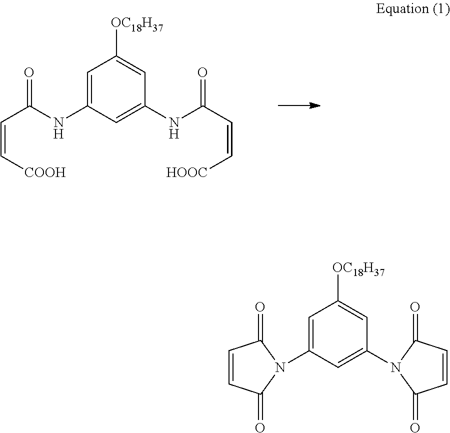

The free radical polymerization reaction causes a polymerization reaction on compounds containing C═C double bonds, such as compounds containing maleimide groups, to form crosslinked structures. An example of such a reaction can be represented by the following Equation (2):

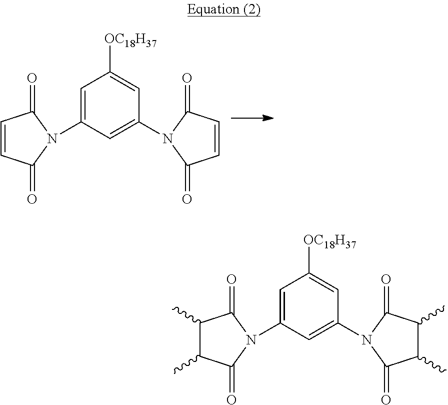

An example of an imidized alignment film obtained through the dehydration/ring-closure reaction (imidization) and free radical polymerization is the alignment film provided with a crosslinked structure represented by the following Formula (51).

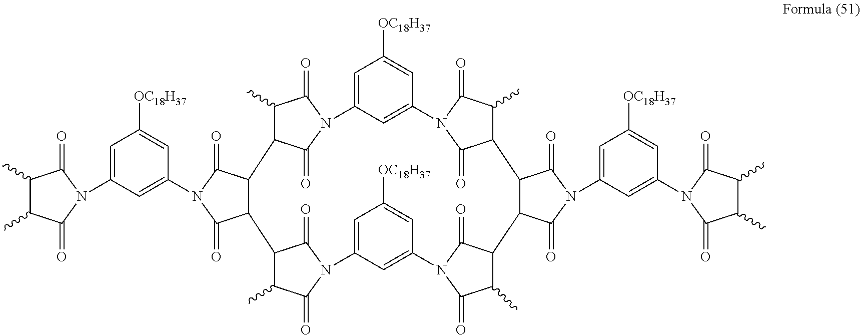

The aforementioned alignment agent to form coating film layer is rubbed in a certain direction with a roller wound with nylon, rayon, or cotton fiber cloth according to needs. Thereby, the alignability of the liquid crystal molecules is provided to the coating film to become a liquid crystal alignment film. Moreover, methods that provide the alignability of the liquid crystal molecules with protrusions or patterns formed on at least one substrate are widely known as MVA (Multi-domain Vertical Alignment) or PVA (Patterned Vertical Alignment) methods.

### Manufacturing of the Liquid Crystal Display Element:

The liquid crystal display element of the present invention can be manufactured by the method as described below.

Two substrates each having the liquid crystal alignment film formed as the aforementioned manufacturing method of the liquid crystal alignment film are prepared and opposed to each other with a space (cell gap). The peripheral portions of the two substrates are joined together with a sealing agent, liquid crystals are filled into the cell gap defined by the surfaces of the substrates and the sealing agent, and an injection hole is sealed up to form a liquid crystal cell. Then, a polarizer is affixed to the exterior sides of the liquid crystal cell, that is, the other sides of the substrates forming the liquid crystal cell to obtain the liquid crystal display element.

The sealing agent can be used an epoxy resin containing a curing agent, and spacer material can be used glass beads, plastic beads, or photosensitive epoxy resin. Examples of liquid crystals include nematic liquid crystals, such as Schiff base liquid crystals, azoxy liquid crystals, biphenyl liquid crystals, phenylcyclohexane liquid crystals, ester liquid crystals, terphenyl liquid crystals, biphenylcyclohexane liquid crystals, pyrimidine liquid crystals, dioxane liquid crystals, bicyclooctane liquid crystals, cubane liquid crystals, and the like. To the above liquid crystals may be added cholesteric liquid crystals, such as cholesteryl chloride, cholesteryl nonanoate, cholesteryl carbonate, a chiral agent marketed under the trade names of C-15 or CB-15 (products of Merck Company), and the like. In addition, the polarizer affixed to the exterior sides of the liquid crystal cell may be used, for example, a polarizer comprising cellulose acetate protective films sandwiching the polarizing film called “H film” which has absorbed iodine while a polyvinyl alcohol is stretched and aligned, or a polarizer composed of the H film itself.

The present invention will be further illustrated by the following examples.

### BRIEF DESCRIPTION OF THE TABLES

Table 1: Components of Synthesis Examples of alignment agents of the present invention, and

Table 2: Components and evaluation results of Examples of alignment agents of the present invention.

### DETAILED DESCRIPTION OF THE EMBODIMENTS OF THE PRESENT INVENTION

### Synthesis Examples of Alignment Agents

### A Molecular Compound Containing at Least 2 Polymerizable Maleamic Acid Groups (A)

### Synthesis Example 1

A 500 ml four-necked conical flask equipped with a nitrogen inlet, a stirrer, a heater, a condenser and a thermometer was purged with nitrogen, and the components shown in Table 1 were charged to the flask. The aforementioned components comprising 3.76 g (0.01 moles) of 1-octadecyloxy-2,4-diaminobenzene (hereinafter abbreviated as C18DA), and 50 g of a solvent of tetrahydrofuran (hereinafter abbreviated as THF) were stirred at room temperature until dissolved, after which 2.45 g (0.025 moles) of maleic anhydride (hereinafter abbreviated as MAn) was added and left to react for 3 hours at room temperature. After the reaction was finished, the reaction solution was filtered, and the solid obtained therefore was repeatedly washed using THF and filtered three times, and then placed into a vacuum oven, where drying was carried out at 60° C., thereby obtaining a compound containing 2 maleamic acid groups (A-1-1).

### Synthesis Example 2 to 4

The operating procedure of Synthesis Example 1 was repeated, except that the kind of the multiple amino group compound, and the dosage of the maleic anhydride were changed. Details were shown in Table 1.

### Polymer (B)

### Synthesis Example 5

A 500 ml four-necked conical flask equipped with a nitrogen inlet, a stirrer, a heater, a condenser and a thermometer was purged with nitrogen, and the components comprising 20 g (0.1 moles) of 4,4′-diaminodiphenylether (hereinafter abbreviated as DDE) and 180 g of a solvent N-methyl-2-pyrrolidone (hereinafter abbreviated as NMP) were charged to the flask. The components were stirred at room temperature until dissolved, after which 10.246 g (0.047 moles) of pyromellitic dianhydride (hereinafter abbreviated as PMDA), 9.8 g (0.05 moles) of cyclobutane tetracarboxylic dianhydride (hereinafter abbreviated as CBTA) and 50.26 g of NMP were added and a reaction was allowed to continue for 6 hours at room temperature. After the reaction was finished, the polyamic acid solution was poured into 1500 ml of water to precipitate the polymer. The polymer obtained after filtering was repeatedly washed using methanol and filtered three times, and then placed into a vacuum oven, where drying was carried out at 60° C., after which the polyamic acid polymer (B-1) was obtained.

### Synthesis Example 6

A 500 ml four-necked conical flask equipped with a nitrogen inlet, a stirrer, a heater, a condenser and a thermometer was purged with nitrogen, and the components comprising 10.8 g (0.1 moles) of p-phenylenediamine (hereinafter abbreviated as PDA) and 100 g of the solvent NMP were charged to the flask. The components were stirred at room temperature until dissolved, after which 33 g (0.11 moles) of 3,4-dicarboxy-1,2,3,4-tetrahydronaphthalene-1-succinic acid dianhydride (hereinafter abbreviated as TDA) and 63 g of NMP were added and a reaction was allowed to continue for 6 hours at room temperature, thereby obtaining a reaction solution of polyamic acid polymer. 7.9 g of acetic anhydride and 51 g of pyridine were further added, the temperature was raised to 60° C. and the contents were stirred continually for 3 hours to carry out imidization. After the reaction was finished, the reaction solution of polyimide polymer was poured into 1500 ml of water to precipitate the polymer. The polymer obtained after filtering was repeatedly washed using methanol and filtered three times, and then placed into a vacuum oven, where drying was carried out at 60° C., after which the polyimide polymer (B-2) was obtained.

### Synthesis Example 7

A 500 ml four-necked conical flask equipped with a nitrogen inlet, a stirrer, a heater, a condenser and a thermometer was purged with nitrogen, and the components comprising 3 g of the polyimide polymer (B-2) obtained from Synthesis Example 6 and 17 g of the solvent NMP were charged to the flask. The components were stirred at room temperature until dissolved, after which 3 g of the polyamic acid polymer (B-1) obtained from Synthesis Example 5 and 17 g of NMP were added and a reaction was allowed to continue for 6 hours at 60° C. After the reaction was finished, the polymer solution was poured into 1500 ml of water to precipitate the polymer. The polymer obtained after filtering was repeatedly washed using methanol and filtered three times, and then placed into a vacuum oven, where drying was carried out at 60° C., after which the polyamic acid-polyimide block copolymer (B-3-3) was obtained.

### Evaluation Method

### (1) Coating Ability:

After coating, the surface of the coating film was viewed using a microscope to check whether there are any coating defects, including pin holes or precipitates.

◯: Surface of the coating film is smooth with no precipitates.
Δ: Surface of the coating film has a few pin holes or a few precipitates.
X: Surface of the coating film has a large number of pin holes or a large number of precipitates.
XX: Unable to coat and form a film.

### (2) Voltage Holding Ratio:

The voltage holding ratio of the liquid crystal cell was measured using an electrical measuring machine (manufactured by TOYO Corporation, Model 6254), with which a 4 volt voltage was applied for 120 microseconds. The applied voltage was held for 16.67 milliseconds, after the applied voltage was cut off for 16.67 milliseconds, the voltage holding ratio was measured and evaluated according to the following standards:

◯: Voltage holding ratio>96%.
Δ: Voltage holding ratio is between 94 to 96%.
X: Voltage holding ratio<94%.

### (3) Reliability:

A reliability test was carried out on the liquid crystal cell at a temperature of 70° C. and relative humidity of 80% for 120 hours, and then the method of Evaluation Method (2) was used to measure the voltage holding ratio, and the liquid crystal cell was evaluated according to the following standards:

◯: Voltage holding ratio>94%.
Δ: Voltage holding ratio is between 90 to 94%.
X: Voltage holding ratio<90%.

### (4) Pretilt Angle:

The pretilt angle was measured by a crystal rotation method using an He—Ne laser light (manufactured by CHUO PRECISION INDUSTRIAL CO., LTD., Model OMS-CM4RD) according to the method described in T. J. Scheffer, et. al., J. Appl. Phys., vol. 19, 2013 (1980).

### Examples and Comparative Examples of A Liquid Crystal Alignment Agent

### Example 1

40 parts by weight of the maleamic acid group compound (A-1-1) obtained from Synthesis Example 1 and 60 parts by weight of the polyamic acid polymer (B-1) obtained from Synthesis Example 5 were dissolved in a cosolvent of 800 parts by weight of NMP/800 parts by weight of butyl cellosolve (hereinafter abbreviated as BC) and allowed to completely dissolve at room temperature. The alignment agent solution obtained was coated onto a glass substrate provided with an ITO (indium-tin-oxide) film using a printing machine (manufactured by Nissha Printing, Model S15-036), after which pre-bake was carried out on a hot plate at a temperature of 80° C. for 2 minutes, and post-bake was carried out in an oven at a temperature of 230° C. for 15 minutes. The film thickness was measured to around 750 Å using a film thickness measuring device (manufactured by KLA-Tencor, Model Alpha-step 500). Two glass substrates having the liquid crystal alignment film were manufactured by the aforementioned steps, thermo-compression adhesive agent was applied to one glass substrate, and spacers of 4 μm were sprayed on the other glass substrate. The two glass substrates were bonded together, and after filling with a nematic liquid crystal, then ultraviolet light was used to harden a sealing agent to seal a liquid crystal injection hole, thereby fabricating a liquid crystal cell. The liquid crystal alignment agent and the liquid crystal cell were evaluated with the Evaluation Method as described above, and the results were shown in Table 2.

### Example 2

The operating procedure of Example 1 was repeated, except that the kind and dosage of the maleamic acid group compound (A), the kind and dosage of the polymer (B) and the dosage of the solvent (C) were changed. Details and evaluation results were shown in Table 2.

### Example 3

The operating procedure of Example 1 was repeated, except that the kind and dosage of the maleamic acid group compound (A), the kind and dosage of the polymer (B), the dosage of the solvent (C) were changed, and the additive agent (D) was added. Details and evaluation results were shown in Table 2.

### Examples 4 to 7

The operating procedure of Example 1 was repeated, except that to perform the alignment process after post-bake, whereby alignment (rubbing) of a surface of the thin film was carried out by using a rubbing machine provided with a roller wound with nylon cloth, a stage moving rate of 35.4 mm/sec, a rotating speed of the roller of 700 rpm, a hair push-in length of 0.3 mm. Moreover, the kind and dosage of the maleamic acid group compound (A), the kind and dosage of the polymer (B), the dosage of the solvent (C) were changed, and the additive agent (D) was added. Details and evaluation results were shown in Table 2.

### Examples 8 and 9

The operating procedure of Example 1 was repeated, except that the kind and dosage of the maleamic acid group compound (A), the kind of the polymer (B), and the kind and dosage of the solvent (C) were changed. Details and evaluation results were shown in Table 2.

### Comparative Example 1

100 parts by weight of the maleamic acid compound of (A-1-1) obtained from Synthesis Example 1 was dissolved in a cosolvent of 800 parts by weight of NMP/800 parts by weight of BC, and allowed to completely dissolve at room temperature. Testing was carried out on the alignment agent solution obtained similar to the operating procedure of Example 1, and the evaluation results obtained were as follows: coating ability: XX.

### Comparative Example 2

A 500 ml four-necked conical flask equipped with a nitrogen inlet, a stirrer, a heater, a condenser and a thermometer was purged with nitrogen, and the components comprising 5 g of the maleamic acid group compound (A-1-1) obtained from Synthesis Example 1 and 50 g of the solvent NMP were charged to the flask. The components were stirred at room temperature until dissolved, after which 5 g of acetic anhydride and 1 g of sodium acetate were added, the temperature was raised to 60° C. and the contents were stirred continually for 6 hours. After the reaction was finished, the reaction solution was poured into 500 ml of water to precipitate the compound; the solid obtained after filtering was repeatedly washed using methanol and filtered three times, and then placed into a vacuum oven, where drying was carried out at 60° C., after which the maleimide group compound was obtained.

100 parts by weight of the maleimide group compound was dissolved in a cosolvent of 800 parts by weight of NMP/800 parts by weight of BC and allowed to completely dissolve at room temperature. Testing was carried out on the alignment agent solution obtained similar to the operating procedure of Example 1, and the evaluation results obtained were as follows: coating ability: XX.

### Comparative Example 3

40 parts by weight of the maleimide group compound obtained from Comparative Example 2 and 60 parts by weight of the polyamic acid polymer (B-1) obtained from Synthesis Example 5 were dissolved in a cosolvent of 800 parts by weight of NMP/800 parts by weight of BC, and allowed to completely dissolve at room temperature. Testing was carried out on the alignment agent solution obtained similar to the operating procedure of Example 1, and the evaluation results obtained were as follows: coating ability: Δ, voltage holding ratio: ◯, reliability: ◯, pretilt angle: 89.6 degrees.

### Comparative Example 4

A 500 ml four-necked conical flask equipped with a nitrogen inlet, a stirrer, a heater, a condenser and a thermometer was purged with nitrogen, and the components comprising 0.93 g (0.01 moles) of aniline and 50 g of the solvent THF were charged to the flask. The components were stirred at room temperature until dissolved, after which 0.98 g (0.01 moles) of MAn was added and a reaction was allowed to continue for 3 hours at room temperature. After the reaction was finished, the reaction solution was filtered, and the solid obtained after filtering was repeatedly washed using THF and filtered three times, and then placed into a vacuum oven, where drying was carried out at 60° C., after which a single maleamic acid group compound was obtained.

40 parts by weight of the single maleimide group compound, 50 parts by weight of the polyamic acid polymer (B-1) obtained from Synthesis Example 5 and 10 parts by weight of the polyimide polymer (B-2) obtained from Synthesis Example 6 were dissolved in a cosolvent of 800 parts by weight of NMP/800 parts by weight of BC, and allowed to completely dissolve at room temperature. Testing was carried out on the alignment agent solution obtained similar to the operating procedure of Example 4, and the evaluation results obtained were as follows: coating ability: ◯, voltage holding ratio: X, reliability: X, pretilt angle: 0.3 degrees.

### Comparative Example 5

A 500 ml four-necked conical flask equipped with a nitrogen inlet, a stirrer, a heater, a condenser and a thermometer was purged with nitrogen, and the components comprising 1.88 g (0.005 moles) of C18DA, 4.86 g (0.045 moles) of PDA and 80 g of the solvent NMP were charged to the flask. The components were stirred at room temperature until dissolved, after which 10.9 g (0.05 moles) of PMDA and 20 g of NMP were added and a reaction was allowed to continue for 2 hours at room temperature. After the reaction was finished, the polyamic acid solution was poured into 1500 ml of water to precipitate the polymer. The polymer obtained after filtering was repeatedly washed using methanol and filtered three times, and then placed into a vacuum oven, where drying was carried out at 60° C., after which the polyamic acid polymer was obtained.

100 parts by weight of the aforementioned obtained polyamic acid polymer was dissolved in a cosolvent of 800 parts by weight of NMP/800 parts by weight of BC at room temperature. The alignment agent solution obtained was coated onto a glass substrate provided with an ITO (indium-tin-oxide) film using a printing machine, after which pre-bake was carried out on a hot plate at a temperature of 100° C. for 5 minutes, and post-bake was carried out in an oven at a temperature of 220° C. for 30 minutes. The film thickness was measured to around 750 Å using a film thickness measuring device (manufactured by KLA-Tencor, Model Alpha-step 500). An alignment process was carried out on the surface of the thin film, after which the liquid crystal cell was assembled. Testing was carried out on the alignment agent solution obtained, and the evaluation results obtained were as follows: coating ability: ◯, voltage holding ratio: Δ, reliability: X, pretilt angle: 4.6 degrees.

### Comparative Example 6

A 500 ml four-necked conical flask equipped with a nitrogen inlet, a stirrer, a heater, a condenser and a thermometer was purged with nitrogen, and the components comprising 5.22 g (0.01 moles) of 17-(1,5-dimethylhexyl)-10,13-dimethylperhydrocyclopenta[α]phenanthren-3-yl 3,5-diaminobenzoate (hereinafter abbreviated as HCDA), 4.32 g (0.04 moles) of PDA and 68 g of the solvent NMP were charged to the flask. The temperature was raised to 60° C. and the components were stirred until dissolved, after which 15 g (0.05 moles) of TDA and 30 g of NMP were added and a reaction was allowed to continue for 6 hours at room temperature, thereby a reaction solution of polyamic acid polymer was obtained. 97 g of NMP, 5.61 g of acetic anhydride and 19.75 g of pyridine were further added, the temperature was raised to 60° C. and the contents were stirred continually for 2 hours to carry out imidization. After the reaction was finished, the reaction solution of polyimide polymer was poured into 1500 ml of water to precipitate the polymer. The polymer obtained after filtering was repeatedly washed using methanol and filtered three times, and then placed into a vacuum oven, where drying was carried out at 60° C., after which the polyimide polymer was obtained.

100 parts by weight of the aforementioned obtained polyimide polymer was dissolved in a cosolvent of 800 parts by weight of NMP/800 parts by weight of BC at room temperature. The operating procedure of Comparative Example 3 was repeated, except that the rubbing process was not carried out. Testing was carried out on the alignment agent solution obtained, and the evaluation results were as follows: coating ability: X, voltage holding ratio: ◯, reliability: ◯, pretilt angle: 89.9 degrees.

While the present invention is illustrated with the preferred embodiments aforementioned, scope of the invention is not thus limited and should be determined in accordance with the appended claims.

TABLE 1
Components of Synthesis Examples of alignment agents

| | | Maleic Anhydride | | | | | | | | | | |
|---|---|---|---|---|---|---|---|---|---|---|---|---|
| | | Derivatives | | Multiple Amino Group Compounds | | | | | | | | |
| | | MAn | | C18DA | | HCDA | | DDM | | PDA | | Mole Ratio of |
| | | | Mole of Acid | | Mole of | | Mole of | | Mole of | | Mole of | Acid Anhydride |
| Synthesis | | | Anhydride | | Amino | | Amino | | Amino | | Amino | Groups/Amino |
| Examples | | Mole | Groups | Mole | Groups | Mole | Groups | Mole | Groups | Mole | Groups | Groups |
| 1 | A-1-1 | 0.025 | 0.025 | 0.01 | 0.02 | — | — | — | — | — | — | 1.25 |
| 2 | A-1-2 | 0.03 | 0.03 | — | — | 0.01 | 0.02 | — | — | — | — | 1.5 |
| 3 | A-2-1 | 0.02 | 0.02 | — | — | — | — | 0.01 | 0.02 | — | — | 1 |
| 4 | A-2-2 | 0.025 | 0.025 | — | — | — | — | — | — | 0.01 | 0.02 | 1.25 |

MAn: Maleic anhydride
C18DA: 1-octadecyloxy-2,4-diaminobenzene
HCDA: 17-(1,5-dimethylhexyl)-10,13-dimethylperhydrocyclopenta[a]phenanthren-3-yl 3,5-diaminobenzoate
DDM: 4,4′-diaminodiphenylmethane
PDA: p-phenylenediamine

TABLE 2
Components and evaluation results of Examples of alignment agents

| | | Examples | | | | | | | | |
|---|---|---|---|---|---|---|---|---|---|---|
| Components | | 1 | 2 | 3 | 4 | 5 | 6 | 7 | 8 | 9 |
| Maleamic Acid Group | A-1-1 | 40 | 20 | 15 | 7 | 5 | 3 | 1 | | |
| Compound (A) (parts | A-1-2 | | | | | | | | 20 | 10 |
| by weight) | A-2-1 | | | 25 | 35 | 40 | 45 | 79 | | |
| | A-2-2 | | | | | | | | 20 | 30 |
| Polymer (B) | B-1 | 60 | 70 | 50 | 20 | | 40 | 20 | 60 | |
| (parts by weight) | B-2 | | 10 | 10 | | | 12 | | | |
| | B-3-3 | | | | 38 | 55 | | | | 60 |
| Organic Solvent (C) | C-1 | 800 | 2000 | 1000 | 1200 | 1400 | 600 | 200 | 800 | 1600 |
| (parts by weight) | C-2 | 800 | 1100 | 600 | 400 | 200 | 1000 | 500 | 800 | |
| Additive Agent (D) | D-1 | | | 2 | 2 | | | 2 | | |
| (parts by weight) | D-2 | | | | | 2 | | | | |
| | D-3 | | | | | | 4 | | | |
| Evaluation Results | Coating Ability | ◯ | ◯ | ◯ | ◯ | ◯ | ◯ | ◯ | ◯ | ◯ |
| | Voltage Holding Ratio (%) | ◯ | ◯ | ◯ | ◯ | ◯ | ◯ | ◯ | ◯ | ◯ |
| | Reliability | ◯ | ◯ | ◯ | ◯ | ◯ | ◯ | ◯ | ◯ | ◯ |
| | Pretilt Angle (degrees) | 89.9 | 89.3 | 88.5 | 7.0 | 4.9 | 3.0 | 1.6 | 89.9 | 89.9 |

C-1: N-methyl-2-pyrrolidone
C-2: Butyl cellosolve
D-1: N,N,N′,N′-tetraglycidyl-4,4′-diaminodiphenylmethane
D-2: N,N,N′,N′-tetraglycidyl-m-xylenediamine
D-3: 1,3-bis(N,N-diglycidylaminomethyl)cyclohexane

1-5. (canceled)

6. A method of forming a liquid crystal alignment film comprising a process of coating a liquid crystal alignment agent onto a substrate, and then processing said alignment agent with dehydration/ring-closure reaction and free radical polymerization, wherein said liquid crystal alignment agent comprises a molecular compound containing at least 2 polymerizable maleamic acid groups (A), a polymer (B), and an organic solvent (C); wherein the polymer (B) comprises at least one kind of polymer obtained from condensation polymerization, which is selected from the groups consisting of polyester, polyesterimide, polyamide-imide acid, polyamide-imide, polyamide acid ester, polyamide and polyimide series polymer.

7. The method of forming a liquid crystal alignment film as claimed in claim 6, wherein said molecular compound containing at least 2 polymerizable maleamic acid groups (A) comprises a compound (A-1) represented by the following Formula (1), 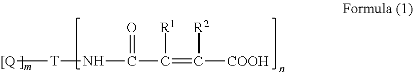
wherein Q comprises a functional group represented by the following Formula (2); T is a structure selected from an aliphatic, an alicyclic and an aromatic hydrocarbon group; R¹ and R² are hydrogen atoms or alkyl groups having 1 to 8 carbon atoms and may be the same or different; m is an integer of 1 or more; n is an integer of 2 or more,
R³-L- Formula (2)
wherein L is a divalent organic group selected from the group consisting of single bond, —O—, —CO—, —COO—, —OCO—, —NHCO—, —CONH—, —S—, methylene group, alkylene group having 2 to 6 carbon atoms and phenylene group; R³ is a monovalent organic group selected from the group consisting of an alkyl group having 6 to 30 carbon atoms, an alicyclic or aromatic or a heterocyclic ring skeleton having 4 to 40 carbon atoms and a fluoroalkyl group having 6 to 12 carbon atoms.

8. The method of forming a liquid crystal alignment film as claimed in claim 7, wherein said compound (A-1) comprises a compound represented by the following Formula (3).

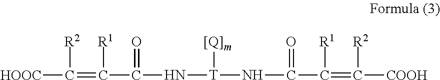

9. The method of forming a liquid crystal alignment film as claimed in claim 7, wherein said molecular compound containing at least 2 polymerizable maleamic acid groups (A) further comprises a compound (A-2) represented by the following Formula (7), 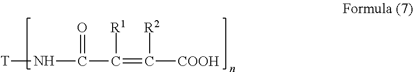
wherein T is a structure selected from an aliphatic, an alicyclic and an aromatic hydrocarbon group; R¹ and R² are hydrogen atoms or alkyl groups having 1 to 8 carbon atoms and may be the same or different; n is an integer of 2 or more.

10. The method of forming a liquid crystal alignment film as claimed in claim 6, wherein said polyimide series polymer comprises a polyamic acid (B-1) and/or a polyimide (B-2) and/or a polyimide series block copolymer (B-3).

11-21. (canceled)
